(19) United States
(12) Patent Application Publication
(10) Pub. No.: US 2003/0021110 A1
(43) Pub. Date: Jan. 30, 2003

(54) Fluorescent lamp

(76) Inventor: Shi Youl Noh, Seoul (KR)

Correspondence Address: JACOBSON HOLMAN, PROFESSIONAL LIMITED LIABILITY COMPANY, 400 SEVENTH STREET, N.W., WASHINGTON, DC, 20004, US

(21) Appl. No.: 09/915,358

(22) Filed: Jul. 27, 2001

(51) Int. Cl. F21S 4/00

(52) U.S. Cl. 362/217

(57) ABSTRACT

Disclosed is a fluorescent lamp which can easily install a plurality of fluorescent lamp bodies. The fluorescent lamp of the present invention includes a fluorescent lamp body enabling a dimming control of a fluorescent light and having a circuit board and a ballast thereinside, a plug being installed on a fluorescent lamp fixture on one side of the fluorescent lamp body to receive a signal and a power, and a socket being installed on a fluorescent lamp fixture on other side of the fluorescent lamp body to apply a signal and a power.

### BACKGROUND OF THE INVENTION

1. Field of the Invention

The present invention relates to a fluorescent lamp, and more particularly, to a fluorescent lamp which can easily install a plurality of fluorescent lamp bodies.

2. Background of the Related Art

In general, a fluorescent lamp signifies a hot cathode low pressure mercury-arc discharge lamp consisting of a tube filled with a mixture of argon weighing approximately 5-6 mmHg and a little mercury vapor. The inside of the tube is coated with phosphors, substances that absorb ultraviolet radiation and fluorescence generated due to discharge of the mercury vapor and reradiate the energy as visible light. Colors of the light are freely selectable according to kinds of the phosphors. Usually, the fluorescent lamp takes a long tube shape. A pair of electrodes at each end are coated with a mixture of tungsten and a material which gives off electrons. The fluorescent lamp is more efficient, has longer life expectancy, and causes less dazzle than an incandescent lamp, and exhibit no darkness thereon over a long time.

In consideration of aesthetic value as well as illumination, the fluorescent lamp employs a fluorescent light having a small diameter to present a fine view of an outer appearance. The small sized fluorescent light is removably installed on a fluorescent lamp fixture of a fluorescent lamp body in which a circuit board is accommodated. Inside the fluorescent lamp body, a rectifying part and a ballast are connected to the circuit board, and a controller is installed to control the ballast, thereby properly controlling brightness and color of the fluorescent light.

In the event that a plurality of fluorescent lamp bodies in which the fluorescent lights are supported by the fluorescent lamp fixtures are installed on a wall or a ceiling, signal lines and power lines connected to the circuit board are connected to and installed on the respective fluorescent lamp bodies. In the fluorescent lamp bodies, since the signal lines and the power lines are connected in series, power supply and lighting of the respective fluorescent lights are simultaneously carried out, and a dimming of the fluorescent light is selectively controlled by the controller, thereby properly controlling luminous intensity.

The aforesaid fluorescent lamp, however, has a disadvantage of increasing inconvenience and decreasing efficiency in connecting the plurality of fluorescent lamp bodies, since the plurality of fluorescent lamp bodies should be connected after the signal lines and the power lines are directly connected to the respective fluorescent lamp bodies.

### SUMMARY OF THE INVENTION

Accordingly, the present invention is directed to a fluorescent lamp that substantially obviates one or more problems due to limitations and disadvantages of the related art.

An object of the present invention is to provide a fluorescent lamp which can easily install a plurality of fluorescent lamp bodies.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a fluorescent lamp including a fluorescent lamp body which enables a dimming control of a fluorescent light and has a circuit board and a ballast thereinside, a plug being installed on a fluorescent lamp fixture on a side of the fluorescent lamp body for receiving a signal and a power, and a socket being installed on a fluorescent lamp fixture on other side of the fluorescent lamp body for forwarding a signal and a power.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a cross view on a side of a preferred embodiment of the present invention;

FIG. 2 illustrates a cross view on other side of the preferred embodiment of the present invention;

FIG. 3 illustrates a state that the preferred embodiment of the present invention is applied;

FIG. 4 illustrates a schematic view of a state that fluorescent lamp bodies are connected by means of a combined signal and power connecting jack according to the present invention;

FIG. 5 illustrates a schematic view of a state that fluorescent lamp bodies are connected by means of a combined signal and power connecting jack according to another preferred embodiment of the present invention; and

FIG. 6 illustrates a state that fluorescent lamp bodies are connected by means of a combined signal and power connecting jack according to still another preferred embodiment.

### DETAILED DESCRIPTION OF THE PREFERRED EMBODIMENTS

Reference will now be made in detail to the preferred embodiments of the present invention, examples of which are illustrated in the accompanying drawings.

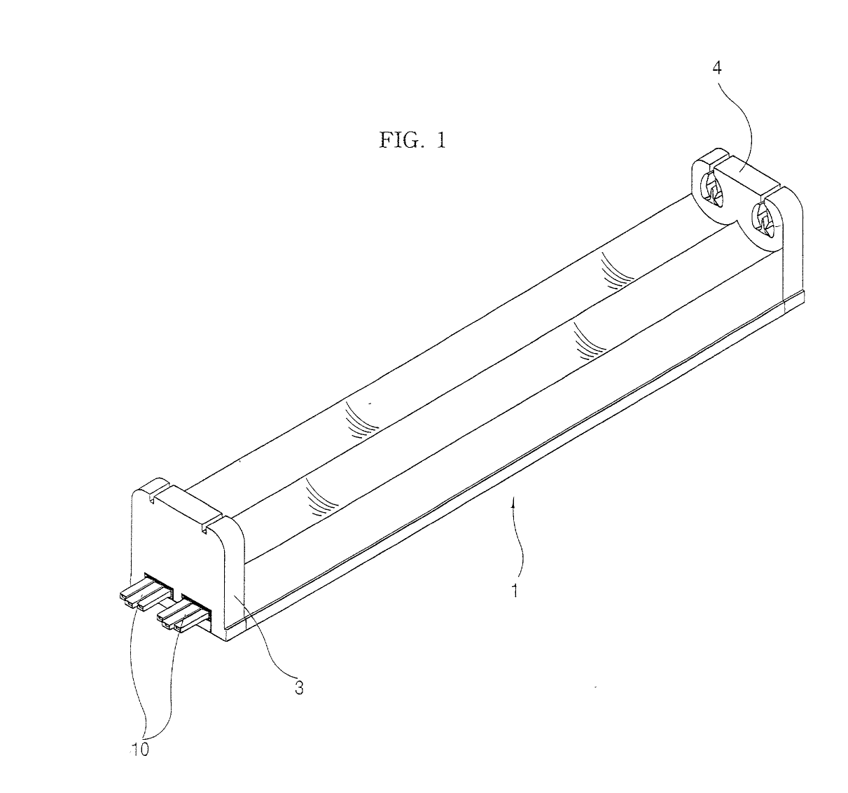

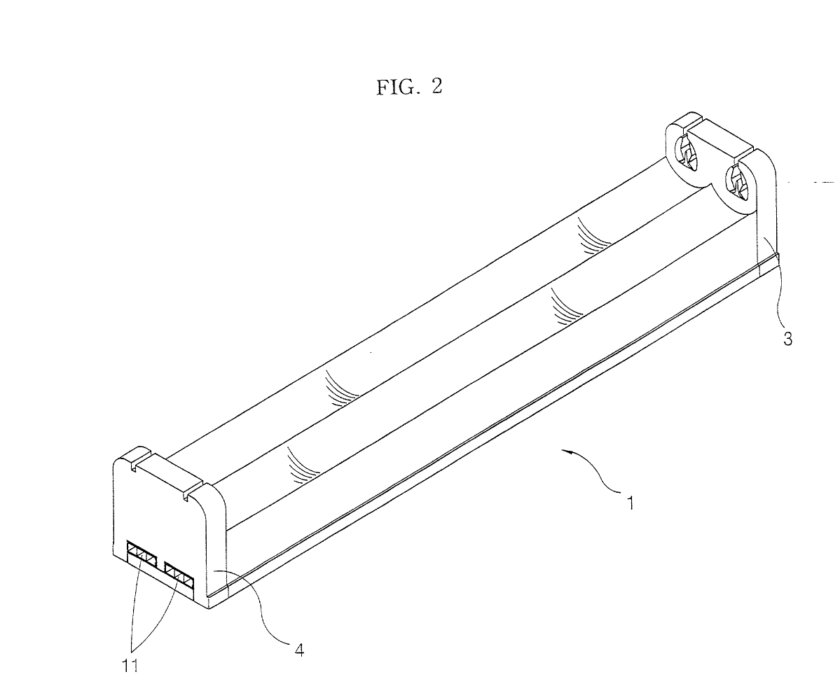

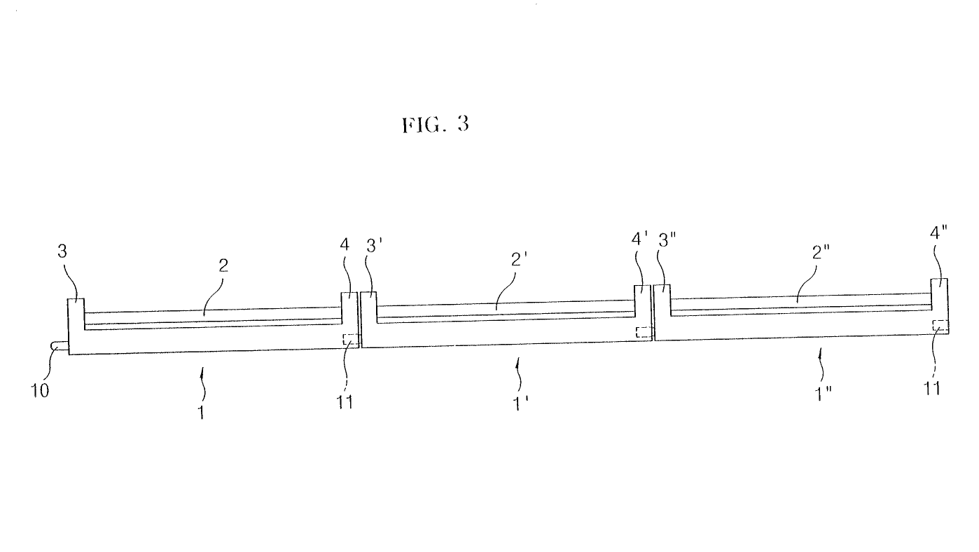

As shown in FIG. 1 to FIG. 6, a fluorescent lamp comprises: a fluorescent lamp body 1 selectively controlling a dimming of a fluorescent light 2 and having a circuit board and a ballast thereinside; a plug 10 being installed on a fluorescent lamp fixture 3 on a side of the fluorescent lamp body 1 for receiving a signal and a power from the outside; and a socket 11 being installed on a fluorescent lamp fixture 4 on other side of the fluorescent lamp body 1 for applying a signal and a power to the outside.

The plug 10 and the socket 11 are connected to a cable which is connected to the circuit board inside the fluorescent lamp body 1. At the same time when a power is applied to the plug 10, the fluorescent light 2 is turned on through the cable and the circuit board. At the same time when a signal is transferred to the plug 10, a dimming control of the fluorescent light 2 is conducted. The power applied to the plug 10 is applied to other fluorescent lamp bodies 1′ and 1″ through sockets 11 and 11′. The signal transferred to the plug 10 is transferred to the other fluorescent lamp bodies 1′ and 1″ through the sockets 11 and 11′.

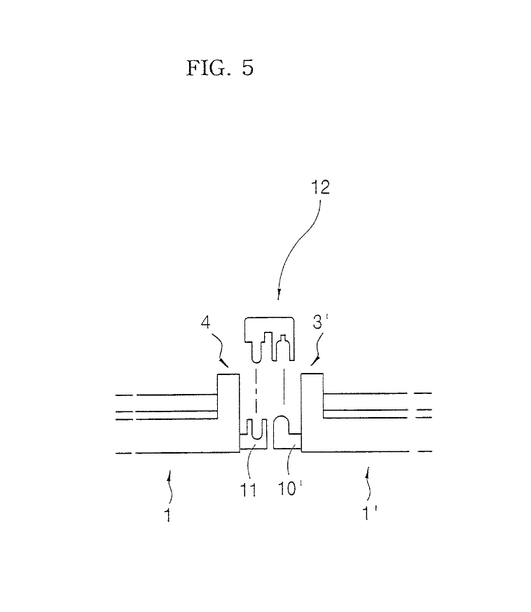

The plugs and sockets are horizontally aligned to be connectable in series. If the fluorescent lamps are not consecutively connected by the plugs and the sockets, they are distanced from each other by a predetermined interval by using a combined and power connecting jack 12. The plug 10′ and the socket 11 may be protruded to the outside of the fluorescent lamp fixtures 3′ and 4 and the plug 10′ and the socket 11 may be shaped like “L” as illustrated in FIG. 5.

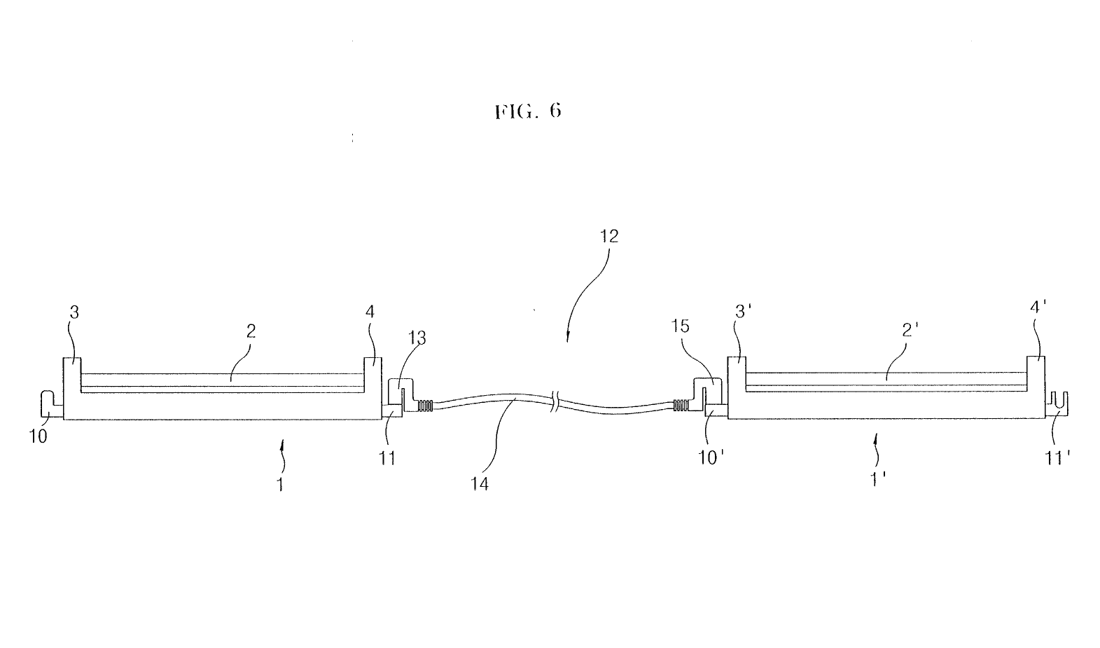

The L-shaped plug 10′ and socket 11 are connected by means of the combined signal and power connecting jack 12 as shown in FIG. 5 and FIG. 6. The combined signal and power connecting jack of FIG. 5 are used in a manner that the fluorescent lamp bodies 1 and 1′ are drawn near to each other and connected by means of the combined signal and power connecting jack 12. Meanwhile, the combined signal and power connecting jack of FIG. 6 is used in a manner that the fluorescent lamp bodies 1 and 1′ are distanced from each other by the predetermined distance and then connected to each other by means of the combined signal and power connecting jack 12.

The combined signal and power connecting jack 12 for connecting the fluorescent lamp bodies by separating the fluorescent lamp bodies by the predetermined interval from each other forms an in-connector 13 connected to the socket 11, an wire 14 connected to the in-connector 13, and an out-connector 15 on an end part of the wire 14 to be connected to the plug 10′.

The present invention constructed as above serves to easily install the plurality of fluorescent lamp bodies. The socket 11 and the plug 10 are formed on the fluorescent lamp fixtures 3 and 4 of the fluorescent lamp body 1. The socket 11 is divided into lines for applying a signal and a power and the plug 10 is divided into lines for receiving a signal and a power. The plug 10 is protruded from the fluorescent lamp fixture 3 on one side of the fluorescent lamp body 1 and the socket 11 is formed on an inside of the fluorescent lamp fixture 4 on other side of the fluorescent lamp body 1.

If the fluorescent lamp bodies are closely installed in series, the plugs and the sockets are coupled to each other. The sockets 11 of the first fluorescent lamp body 1 is electrically connected to the plug 10′ of the second fluorescent lap body 1′. The socket 11′ of the second fluorescent lamp body 1′ is electrically connected to the plug 10″ of the third fluorescent lamp body 1″. The plugs 10′ and 10″ and the sockets 11 and 11′ face each other and are connected to each other, so that the power and signal are exactly applied and transferred

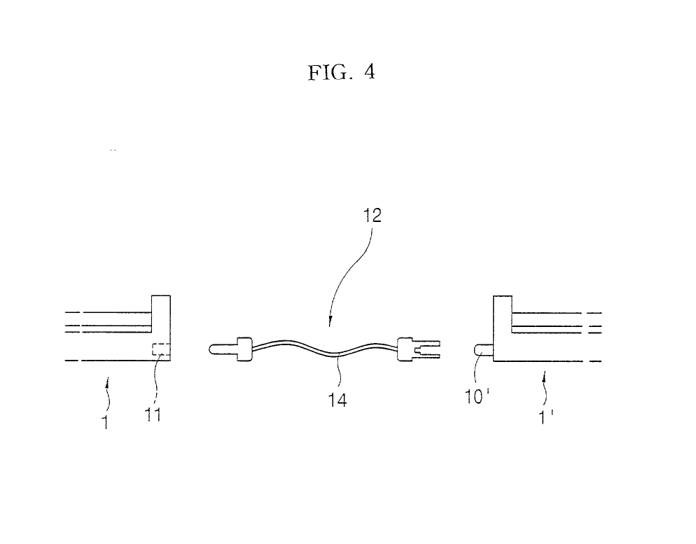

On the other hand, if the fluorescent lamp bodies which may be closely installed as above are separated from each other by the predetermined interval, the combined signal and power connecting jack 12 is used as shown in FIG. 4 to FIG. 6. The combined signal and power connecting jack 12 of FIG. 4 is connected to the socket 11 of the fluorescent lamp body 1 and to the plug 10′ of the fluorescent lamp body 1′, respectively, to connect the fluorescent lamp bodies 1 and 1′. The combined signal and power connecting jack 12 of FIG. 5 is connected to the socket 11 protruded to the outside of the fluorescent lamp body 1 and to the plug 10′ protruded to the outside of the fluorescent lamp body 1′, respectively, to connect the fluorescent lamp bodies 1 and 1′.

The combined signal and power connecting jack 12 of FIG. 6 is connected to the socket 11 protruded to the outside of the fluorescent lamp body 1 and to the plug 10′ protruded to the outside of the fluorescent lamp body 1′. The in-connector 13 of the combined signal and power connecting jack 12 is connected to the socket 11 of the first fluorescent lamp body 1, while the out-connector 15 of the combined signal and power connecting jack 12 is connected to the plug 10′ of the second fluorescent lamp body 1′. An in-connector 13′ of another combined signal and power connecting jack 12′ is electrically connected to the socket 11′ of the second fluorescent lamp body 1′, while an out-connector 15′ of the another combined signal and power connecting jack 12′ is electrically connected to a plug of a continuous fluorescent lamp body. The combined signal and power connecting jack 12 of FIG. 4 and FIG. 6 enables the fluorescent lamp bodies 1, and 1′ to be separated from each other by the predetermined interval, resulting in a simple and convenient installing and repairing process.

As stated above, according to the present invention, the plug for receiving the signal and power is installed on the fluorescent lamp fixture on one side of the fluorescent lamp body, and the socket for applying the signal and power is installed on the fluorescent lamp fixture on other side of the fluorescent lamp body. If the plurality of fluorescent lamp bodies are closely connected in series, the present invention has an advantage of achieving a convenient installing process by simply connecting the plug of one fluorescent lamp body and the socket of other fluorescent lamp body.

If the plurality of fluorescent lamp bodies are distanced from each other by the predetermined interval by using the combined signal and power connecting jack, the present invention has another advantage of ensuring a simple installing process by connecting the in-connector of the combined signal and power jack to the socket of one fluorescent lamp body and connecting the out-connector of the combined signal and power connecting jack to the plug of other fluorescent lamp body.

The present invention has yet another advantage of ensuring a convenient and fast installing and repairing process by drawing the fluorescent lamp bodies near to each other or separating the fluorescent lamp bodies from each other and then connecting the fluorescent lamp bodies by means of the combined signal and power connecting jack.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A fluorescent lamp comprising:
a fluorescent lamp body enabling a dimming control of a fluorescent light, and having a circuit board and a ballast thereinside;
a plug being installed on a fluorescent lamp fixture on one side of the fluorescent lamp body for receiving a signal and a power; and
a socket being installed on a fluorescent lamp fixture on other side of the fluorescent lamp body for applying a signal and a power.

2. The fluorescent lamp of claim 1, wherein a combined signal and power connecting jack is installed to connect the socket and a plug.

3. The fluorescent lamp of claim 1, wherein the socket and the plug are protruded from the fluorescent lamp body, and the combined signal and power connecting jack is a cap type to connect the socket and a plug.

4. The fluorescent lamp of claim 3, wherein the combined signal and power connecting jack installed in the form of a line having a predetermined length connects the socket with a plug.
